(19) United States
(12) Patent Application Publication
(10) Pub. No.: US 2002/0148210 A1
(43) Pub. Date: Oct. 17, 2002

(54) Harvester pickup reel

(75) Inventor: Donald W. Bickel, Peru, IL (US)

Correspondence Address: Edward R. Lawson Jr., Michael Best & Friedrich LLP, 100 East Wisconsin Avenue, Milwaukee, WI, 53202-4108, US

(73) Assignee: HCC, inc., Mendota, IL

(21) Appl. No.: 10/102,164

(22) Filed: Mar. 20, 2002

Related U.S. Application Data
(60) Provisional application No. 60/283,456, filed on Apr. 12, 2001.

(51) Int. Cl. A01D 57/02

(52) U.S. Cl. 56/14.4; 56/226

(57) ABSTRACT

A pickup reel for a harvester. The harvester includes a harvesting platform including a frame having a front edge and a cutter bar extending along the front edge. The pickup reel includes a reel support supported by the frame, a first shaft rotatably supported by the reel support and extending along an axis transverse to the frame, an arm extending radially from and being rotatable with the first shaft, a second shaft supported by the arm and being generally parallel to and radially spaced from the first shaft, the second shaft being rotatable relative to and rotatable with the arm, and a plurality of tines supported by the second shaft for rotation with the second shaft, each of the plurality of tines having a tip, the tips being movable along a tip path during rotation of the first shaft. Also, the pickup reel includes a cam defining a generally endless cam path extending about the first shaft, a cam follower engageable with the cam and movable along the cam path, a crank arm connected between the cam follower and the second shaft, and a retainer for the cam path arrangement. The retainer includes, on one of the cam and the cam follower, a first surface and a second surface axially spaced from the first surface, and a portion of the other of the cam at the cam follower position between the first surface and the second surface to retain the cam follower in engagement with the cam during movement of the cam follower along the cam path. Rotation of the first shaft and movement of the cam follower along the cam path cooperate to cause the tips to move along the tip path.

### RELATED APPLICATIONS

The present application claims the benefit of co-pending provisional patent application Serial No. 60/283,456, filed on Apr. 12, 2001.

### FIELD OF THE INVENTION

The present invention relates to harvesters and, more particularly, to a pickup reel for a harvester.

### BACKGROUND OF THE INVENTION

A typical harvester includes a harvesting platform including a frame supported for movement over ground, the frame having a front edge, a cutter bar extending along the front edge, and a pickup reel for lifting crop into the harvester. Generally, a pickup reel includes a reel support supported by the frame, a shaft rotatably supported by the reel support and extending along an axis transverse to the frame, a plurality of arms extending radially from and being rotatable with the shaft, a plurality of second shafts, each supported by at least one of the arms and being generally parallel to and radially spaced from the first shaft, the second shafts being rotatable relative to and rotatable with the arm, and a plurality of tines supported by each second shaft for rotation with the second shaft. The tips of the tines are movable along a tip path during rotation of the first shaft.

In some constructions, the pickup reel may also include an arrangement for defining the tip path. A typical arrangement includes a cam defining a generally endless cam path extending about the first shaft, a cam follower engageable with the cam and movable along the cam path, and a crank arm connected between a cam follower and a second shaft. Rotation of the first shaft and movement of the cam follower along the cam path cooperate to cause the tips to move along the tip path. Exemplary arrangements are illustrated in U.S. Pat. Nos. 5,768,870; 5,595,053; 5,566,536; 5,007,235; and 4,008,558.

### SUMMARY OF THE INVENTION

One independent problem with the above-described harvesters and pickup reels is that, as the cam follower moves along the cam path, the cam follower disengages from the cam and “falls out” of the track defined by the cam. When this occurs, the associated second shaft and tines are freely rotatable, and the tines do not properly engage the crop. Operation of the harvester must stopped to reengage the cam follower with the cam.

Another independent problem with the above-described harvesters and pickup reels is that, during operation of the pickup reel and rotation of the first shaft, the cam follower frequently reverses its direction of rotation as the cam follower moves along the cam path because of the configuration of the cam path. This frequent reversing action can cause additional wear on the cam follower and on the cam in the areas in which the reversing action occurs.

Yet another independent problem with the above-described harvesters and pickup reels is that the construction of the cam results in difficult assembly of the cam path arrangement and in more difficult installation of the cam followers.

A further independent problem with the above-described harvesters and pickup reels is that the construction of the cam does not allow the cam path to be varied or does not allow the cam path to be varied without replacement of the entire cam.

Another independent problem with the above-described harvesters and pickup reels is that the cam arrangement does not provide a control mechanism for the tines which enables the tip path to be optimized, and the tip path cannot be selectively varied to accommodate, for example, different harvesters and/or crops.

Yet another independent problem with the above-described harvesters and pickup reels is that the tip path defined by the cam path arrangement does not provide the optimal engagement of the tines with the crop to pick the crop up and deposit the crop on the harvester platform.

A further independent problem with the above-described harvesters and pickup reels is that the entire cam must be replaced if the cam is worn or to change the tip path.

The present invention provides a harvester, a pickup reel and a retainer for the cam path arrangement which substantially alleviates one or more of these and other problems with the above-described harvesters and pickup reels. In some aspects of the invention, with the retainer, the cam follower is retained in engagement with the cam during movement of the cam follower along the cam path. In other aspects of the invention, the cam and the cam follower are configured to reduce the wear on these components which may be caused by the frequent reversing action of the cam follower as the cam follower moves along the cam path.

More particularly, the present invention provides a pickup reel for a harvester, the harvester including a harvesting platform including a frame having a front edge and a cutter bar extending along the front edge. The pickup reel includes a reel support supported by the frame, a first shaft rotatably supported by the reel support and extending along an axis transverse to the frame, an arm extending radially from and being rotatable with the first shaft, a second shaft supported by the arm and being generally parallel to and radially spaced from the first shaft, the second shaft being rotatable relative to and rotatable with the arm, and a plurality of tines supported by the second shaft for rotation with the second shaft, each of the plurality of tines having a tip, the tips being movable along a tip path during rotation of the first shaft. Also, the pickup reel is defined as including a cam defining a generally endless cam path extending about the first shaft, a cam follower engageable with the cam and movable along the cam path, and a crank arm connected between the cam follower and the second shaft. Rotation of the first shaft and movement of the cam follower along the cam path cooperate to cause the tips to move along the tip path.

In addition, the pickup reel is defined as including a retainer for the cam path arrangement. The retainer is defined as including, on one of the cam and the cam follower, a first surface and a second surface axially spaced from the first surface, and a portion of the other of the cam at the cam follower position between the first surface and the second surface to retain the cam follower in engagement with the cam during movement of the cam follower along the cam path.

Preferably, the cam includes an inner cam ring and an outer cam ring spaced radially outwardly of the inner cam ring, the inner cam ring and the outer cam ring defining a cam channel therebetween. The cam follower is movable in the cam channel and along the cam path, and the cam follower provides the first surface and the second surface. Preferably, a portion of at least one of the inner cam ring and the outer cam ring is positioned between the first surface and the second surface to retain the cam follower in engagement with the cam during movement of the cam follower in the cam channel.

The cam follower may have a first flange portion, a second flange portion spaced axially from the first flange portion, and an intermediate portion positioned between the first flange portion and the second flange portion. At least one of the inner cam ring and the outer cam ring has a cam surface engageable with the intermediate portion axially between the first flange portion and the second flange portion to retain the cam follower in engagement with the cam during movement of the cam follower along the cam path. The flanged cam follower is preferably captured between the inner cam ring and the outer cam ring, and the inner cam ring and the outer cam ring are preferably captured by the flanged cam follower to retain the cam follower in engagement with the cam during movement of the cam follower along the cam path.

The tines may have a pitch relative to the pickup reel. The cam preferably has a first portion and a second portion. Movement of the cam follower along the first portion of the cam results in a first pitch of the tines, and movement of the cam follower along the second portion of the cam results in a second pitch of the tines.

The cam path may be configured to provide a tip path having an approach zone, in which the plurality of tines extend outwardly from the reel and tips move in a generally horizontal path to sweep the ground forward of the cutter bar, and a lift zone, in which the second shaft rotates in a direction relative to the ground to lift the tips over the cutter bar and above the frame. The harvester may further include a crop dam rearward of the cutter bar, and, in the lift zone, the tines may lift the crop over the crop dam. Also, in the lift zone, the tips may move upward and rearward relative to the cutter bar. The cam path may be configured to provide a release zone following the lift zone, in which the second shaft rotates in a direction opposite the direction of rotation of the second shaft during the lift zone to move the tips forward relative to the cutter bar to release crop from the tines and to provides clearance between the tines and a platform auger.

In the approach zone and in the lift zone, the tines may be oriented at an advanced angle relative to a radial plane, and, during the lift zone, the second shaft may be rotated to increase the angle of advance of the tines. During the approach zone and during the lift zone, the tines may be oriented at an advanced angle relative to a radial plane and, during the release zone, the second shaft may be rotated to move the tines to a delayed angle relative to a radial plane.

Preferably, the cam includes a first cam segment and a second cam segment, the first cam segment and the second cam segment being connectable to define the cam path. One of the first cam segment and the second cam segment may be selectively removable and replaceable with a third cam segment, the third cam segment and the other of the first cam segment and the second cam segment being connectable to define a second cam path different than the first-mentioned cam path. The cam follower is movable along this second cam path to cause the tips to move along a second tip path different than the first-mentioned tip path. Also, one of the first cam segment and the second cam segment may form a crop engagement region of the cam path, the tines being engageable with crop during movement of the cam follower in the crop engagement region of the cam path.

In another aspect of the invention, the flanged cam follower may include a cam follower body, providing the first and second flange portions and the intermediate portion, and a sleeve rotatably supported on the cam follower body. The cam sleeve is preferably rotatable relative to the cam follower body to reduce the wear on the cam follower and on the cam.

Also, the present invention provides a harvester including a harvesting platform including a frame having a front edge, and a cutter bar extending along the front edge, a cam path pickup reel including a cam path arrangement, and a retainer for the cam path arrangement. The retainer may include a cam, provided by an inner cam ring and an outer cam ring, and a flanged cam follower captured by the cam.

In addition, the present invention provides a cam path arrangement retainer for a cam path pickup reel. The cam path pickup reel includes a cam path arrangement including a cam defining a generally endless cam path extending about the first shaft, a cam follower engageable with the cam and movable along the cam path, and a crank arm connected between the cam follower and the second shaft. Rotation of the first shaft and movement of the cam follower along the cam path cooperate to cause the tips to move along the tip path. The retainer retains the cam follower in engagement with the cam during movement of the cam follower along the cam path. The retainer may include a cam, provided by an inner cam ring and an outer cam ring, and a flanged cam follower captured by the inner cam ring and the outer cam ring.

One independent advantage of the invention is that, in some aspects of the invention, the retainer eliminates the possibility of the cam follower “falling out” of the track defined by the cam. The inner cam ring and the outer cam ring cooperate to capture the flanged cam follower, and the flanged cam follower captures the inner cam ring and the outer cam ring.

Another independent advantage of the invention is that, in some aspects of the invention, the cam sleeve is rotatably supported on the cam follower body to reduce the wear on the cam and the cam follower which may be caused by the frequent reversing action of the cam follower as it is moved along the cam path.

Yet another independent advantage of the invention is that construction of the cam as inner and outer cam rings and as separate cam segments results in easier assembly of the cam path arrangement and in easier installation of the cam followers.

A further independent advantage of the invention is that construction of the cam as cam segments results in an infinite variety of cam paths which may be easily manufactured without special tooling or methods.

Another independent advantage of the invention is that the cam arrangement provides a control mechanism for the tines which enables the tip path to be optimized. The construction of the cam as cam segments enables the tip path to be selectively varied to accommodate, for example, different harvesters and/or crops.

Yet another independent advantage of the invention is that, with a selected optimal tip path, there is greater engagement of the tines with the crop to pick the crop up and deposit the crop farther rearwardly on the harvester platform.

A further independent advantage of the present invention is that, because the cam is constructed of multiple cam segments, a cam segment may be replaced if worn or change the tip path without requiring replacement of the entire cam.

Other independent features and independent advantages of the present invention will become apparent to those skilled in the art upon review of the following detailed description, claims and drawings.

### BRIEF DESCRIPTION OF THE DRAWINGS

FIG. 1 is a side view of a harvester including a cam path pickup reel and a cam path arrangement retainer embodying the present invention.

FIG. 2 is a side view similar to that in FIG. 1 and illustrating the tip path.

FIG. 3 is a side view of a portion of the harvester including the cam.

FIG. 4 is a partial cross-sectional view of the cam path arrangement and the retainer.

FIG. 5 is a partial cross-sectional view similar to that in FIG. 4.

FIG. 6 is a perspective view of a portion of the harvester.

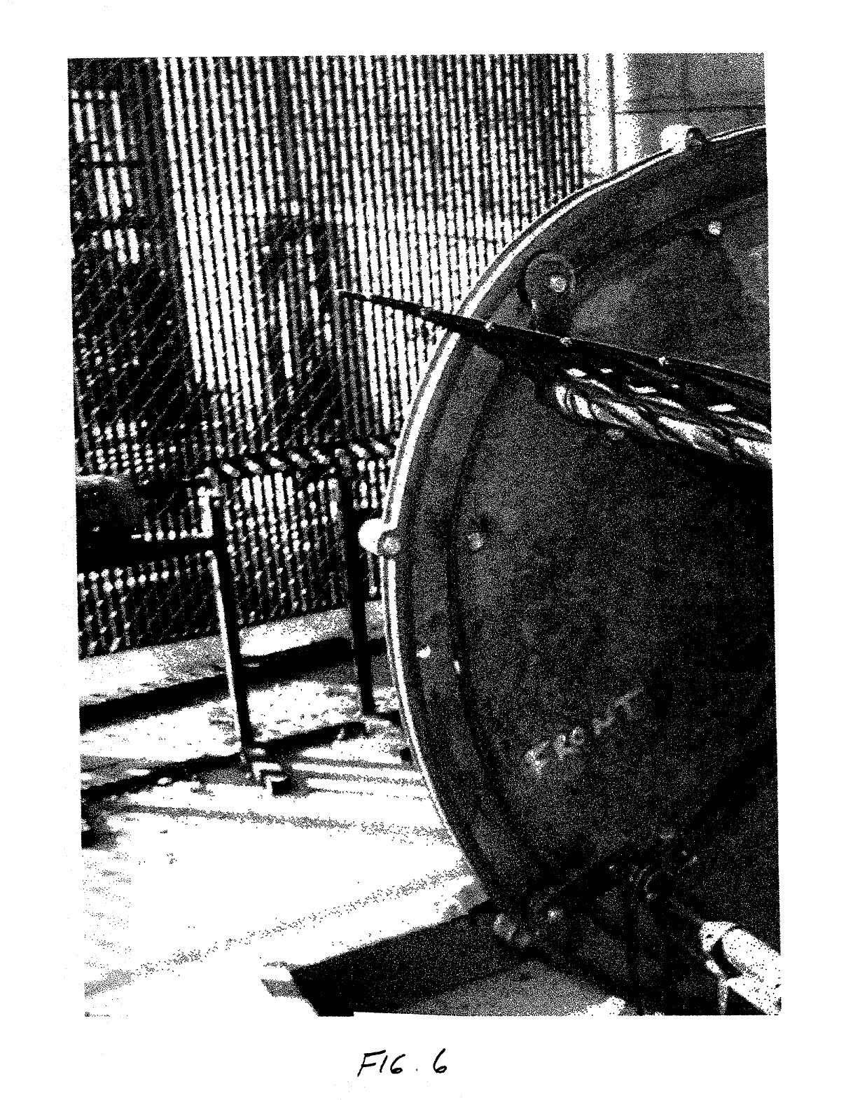

Before one embodiment of the invention is explained in detail, it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting.

### DETAILED DESCRIPTION OF THE PREFERRED EMBODIMENT

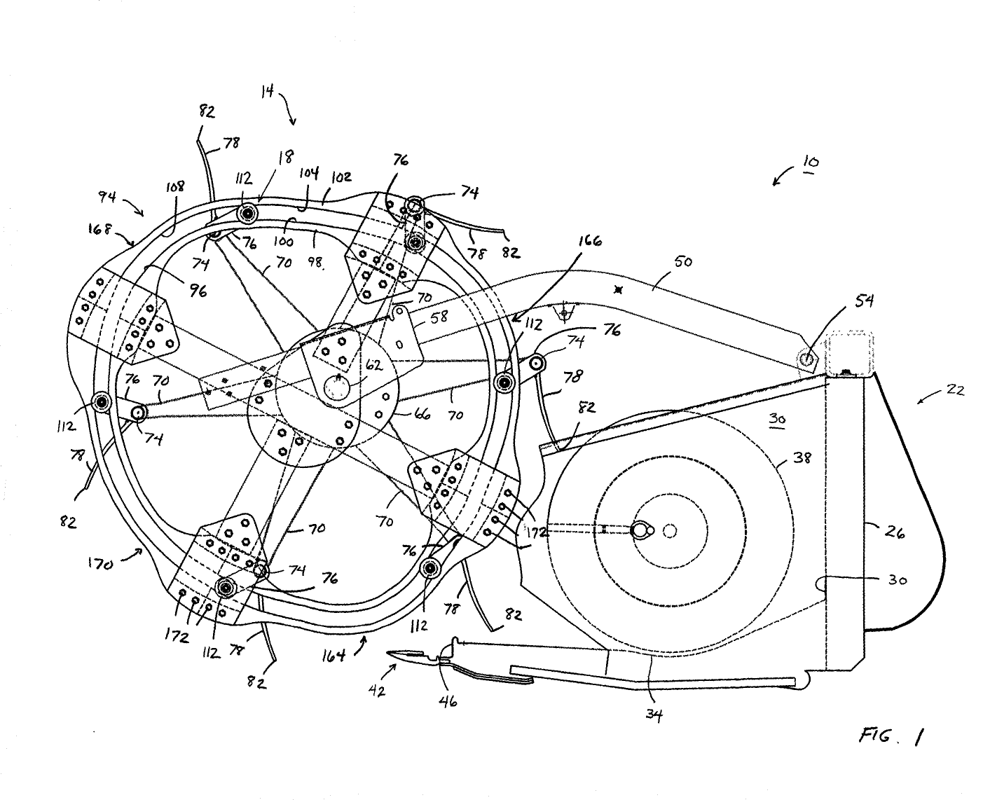

A harvester 10 including a cam path pickup reel 14 and a cam arrangement retainer 18 embodying the invention is illustrated in FIG. 1. The harvester 10 includes a harvesting platform 22 including a platform frame 26 supported for movement over ground and side and rear walls 30. A floor 34 extends between the opposite side walls 30. A transverse crop converging auger 38 is rotatably supported above the floor 34 and forward of the rear wall 30. A transverse cutter bar 42 is mounted along the forward edge of the floor 34, and an upright crop dam 46 is supported between the cutter bar 42 and the floor 34.

The pickup reel 14 generally spans the width of the platform 22, forward of the auger 38 and above the cutter bar 42. The pickup reel 14 is connected to the platform 22 by a pair of reel support arms 50 (one shown) which support the pickup reel 14 on the frame 26. In the illustrated construction, the support arms 50 are pivotally connected to the frame 26 at pivot points 54. The support arms 50 are generally above the side walls 30 of the platform 22. Preferably, the support arms 50 are selectively vertically adjustable by a pair of cylinders (not shown) connected between the support arms 50 and the side walls 30.

Movable support structures 58 are supported at the forward ends of each support arm 50. The support structures 58 are generally slidable between forward and rearward positions on the support arms 50, and their movement is controlled by a pair of cylinders (not shown). The support arms 50 and the support structures 58 are adjustably positioned to adjust the position of the pickup reel 14 relative to the platform 22.

A tubular reel shaft or first shaft 62 is journalled by and extends between the support structures 58. The first shaft 62 is rotatable relative to the support structures 58 about its axis. A plurality of axially-spaced, radially-extending members or spiders 66 are supported on the first shaft 62 for rotation with the first shaft 62. Each spider 66 includes a plurality of radially-extending arms 70 (six in the illustrated construction) which are axially aligned with the arms 70 on adjacent spiders 66 to form sets of arms 70.

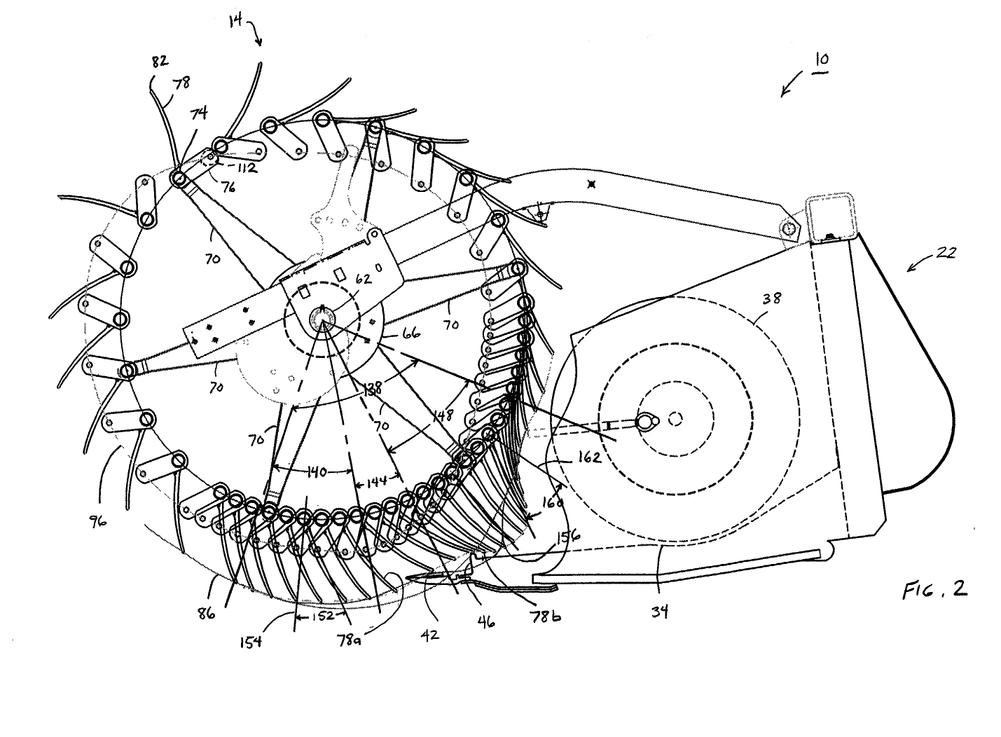

A transverse bat tube, rockshaft or second shaft 74 is journalled in the outer ends of each set of arms 70. The second shafts 74 are rotatable with the associated arms 70 and are rotatable relative to the associated radially-extending arms 70. The second shafts 74 span the width of the pickup reel 14 and are generally parallel to and radially spaced from the first shaft 62. A crank arm 76 (one shown) is connected to the opposite ends of each second shaft 74 to rotate the second shaft 74 about its axis relative to the associated arms 70. A plurality of harvesting tines 78 are connected to each second shaft 74 for rotation with the second shaft 74. Each tine 78 has a tip 82 which is movable along a tip path 86 (shown in detail in FIG. 2).

A cam path arrangement 90 defines the tip path 86 and, in the illustrated construction, includes (see FIGS. 1-4) a pair of cams 94 (one shown) supported at each end of the pickup reel 14. In other constructions (not shown), only a single cam 94 may be used.

In the illustrated construction, the cams 94 control the angular position of the second shafts 74 and the tines 78. Each cam 94 defines a cam path 96 and includes an inner cam ring 98, having a cam surface 100, and an outer cam ring 102, spaced radially outwardly of the inner cam ring 98 and having a cam surface 104. The inner and outer cam rings 98 and 102 define a cam track or cam channel 108.

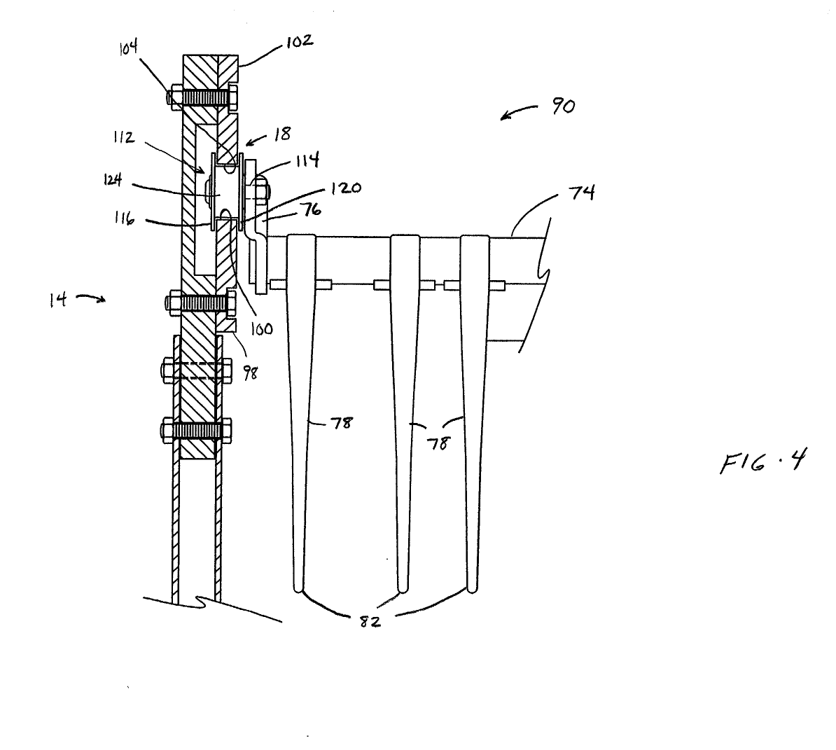

The cam path arrangement 90 also includes a cam follower 112 engageable with the cam 94 and rotatably supported on (see FIG. 4) a cam follower stud 114 connected to each crank arm 76. As shown in FIGS. 1-2 and 4, the cam followers 112 are movable along the cam path 96. Rotation of the first shaft 62 and movement of the cam follower 112 along the cam path 96 cooperate to cause the tips 82 to move along the selected tip path 86.

In the illustrated construction, the cam follower 112 is (see FIG. 4) a shouldered or flanged cam follower. In the illustrated construction, the cam follower 112 includes a first flange portion 116, providing a first retainer surface, a second flange portion 120, axially spaced from the first flange portion and providing a second retainer surface, and an intermediate portion 124, between and having a reduced diameter relative to the first and second flange portions 116 and 120.

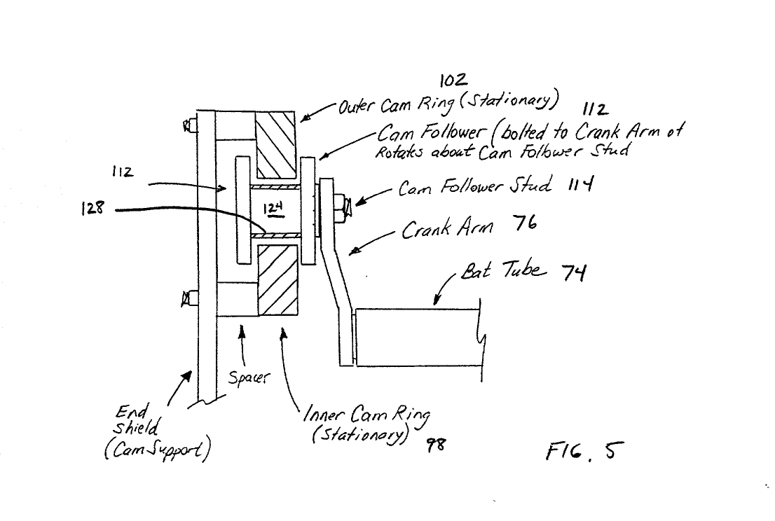

In some constructions, the cam follower 112 also includes (see FIG. 5) a cam follower sleeve 128 rotatably supported on the intermediate portion 124 of the cam follower body to reduce the wear on the cam follower 112 and on the cam 94.

In the illustrated construction, the cam 94 and the cam follower 112 cooperate to provide the cam path arrangement retainer 18. Specifically, the inner and outer cam rings 98 and 102 cooperate to capture the cam follower 112, and the first and second flanges 116 and 120 on the cam follower 112 capture the inner and outer cam rings 98 and 102. As a result, the retainer 18 retains the cam follower 112 remains in engagement with the cam 94 during movement of the cam follower 112 along the cam path 96. The retainer 18 prevents unwanted axial movement of the cam follower 112 relative to the cam 94 (i.e., “falling out” of the cam 94).

The cam path arrangement 90 may be configured to provide any tip path. In the illustrated construction, the cam path arrangement 90 is configured to provide a cam path similar to that shown in U.S. Pat. No. 6,170,244, which is hereby incorporated by reference.

FIG. 2 illustrates the tip path 86 in greater detail. A crop engagement region 138 is shown between two radial lines, approximately from a seven o'clock position to a four o'clock position as the pickup reel 14 rotates counterclockwise (in FIG. 2). The crop engagement region 138 has various zones in which the attitude or pitch of the tines 78 is varied to improve the handling of crop by the pickup reel 14.

In an approach zone 140, the tines 78 extend outwardly from the pickup reel 14, and the tips 82 move in a generally horizontal path to sweep the ground forward of the cutter bar 42. As the cam followers 112 move along the corresponding approach portion of the cam path 96, the second shafts 74 are rotated slightly, relative to the ground, in a counterclockwise direction (in FIG. 2) to maintain the tips 82 in a generally horizontal path. The approach zone 140 ends generally at the position of the tine 78a.

After the approach zone 140, the tines 78 move through a lift zone 144, in which, as the cam followers 112 move along the corresponding lift portion of the cam path 96, the second shafts 74 are rotated further in the counterclockwise direction, relative to the ground, to lift the tips 82 and the crop over the cutter bar 42 and over the crop dam 46. The lift zone 144 ends generally at the position of the tines 78b.

Following the lift zone 144, the tines 78 sweep over the forward portion of the floor 34, at the beginning of a release zone 148. In the release zone 148, as the cam followers 112 move along the corresponding release portion of the cam path 96, the second shafts 74 are rotated in a clockwise direction (in FIG. 2) relative to the ground. This rotation causes the tines 78 to move to a more vertical orientation and allows any crop on the tines 78 to fall to the platform 22. The tines 78 continue to rotate clockwise after the release zone 148 so that the tips 82 clear the auger 38. The clockwise rotation of the tines 78 in and following the release zone 148 allows the tines 78 to sweep over the forward portion of the floor 34 and still clear the auger 38.

In the approach zone 140, the tines 78 are at an angle 152 relative to a radial plane 154, advanced in the counterclockwise direction of rotation of the pickup reel 14. In the release zone 148, the second shaft 74 is rotated clockwise, moving the tines 78 through a zero angle relative to a radial plane 156 to an angle 160 relative to a radial plane 162, delayed in the counterclockwise direction of rotation of the pickup reel 14. Between the eleven and ten o'clock positions of the pickup reel 14, the second shafts 74 are rotated counterclockwise to flip the tines 78 over to an advanced angle as the tines 78 prepare to again enter the approach zone 140.

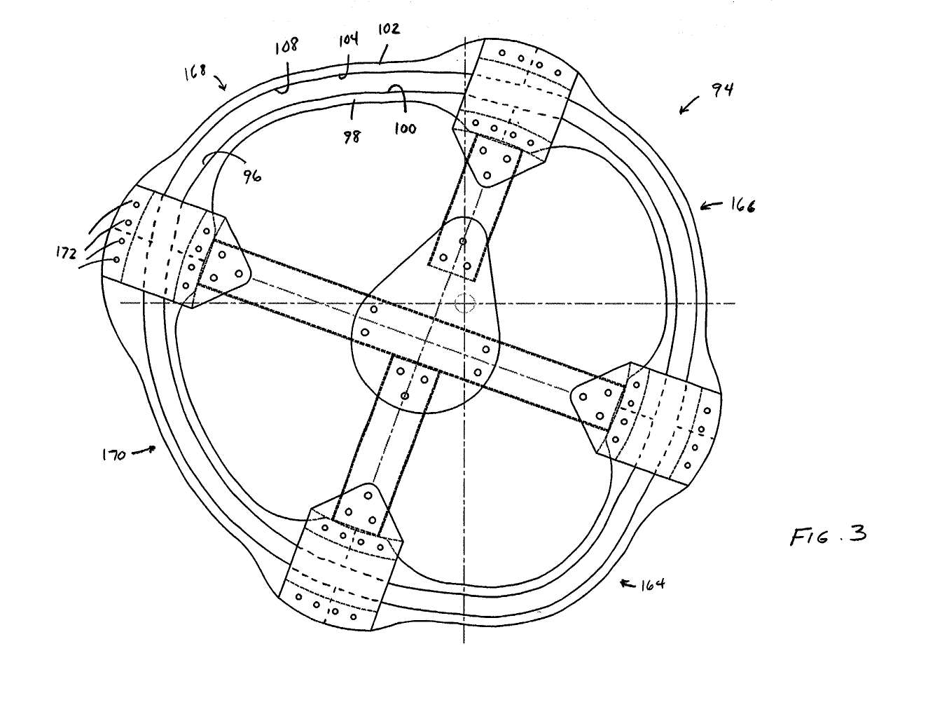

As shown in FIGS. 1 and 3, the cam 94 is preferably formed of multiple cam segments, such as cam segments 164, 166, 168 and 170. The cam segments 164, 166, 168 and 170 are connected at their ends by fasteners 172 to provide the endless cam path 96. If a different or second cam path (not shown but different than the first cam path 96) is desired, for example, in the crop engagement region 138, the first cam segment 164 may be removed and replaced with another cam segment (not shown) having a different cam path portion to provide a different cam path.

Also, in the crop engagement region 138, the cam segment 164 is subject to greater wear. The construction of the cam 94 as cam segments 164, 166, 168 and 170 allow the more worn cam segment (for example, cam segment 164) to be replaced without requiring replacement of the entire cam 94.

The cam path retainer arrangement 18 prevents the cam follower 112 from falling out of the cam channel 108 of the cam 94 as the cam follower 112 moves along the cam path 96. The cam follower 112 is preferably flanged, thereby being captured between the inner and outer cam rings 98 and 102 during assembly. As the pickup reel 14 rotates, the cam follower 112 tracking in the cam channel 108 and moving along the cam path 96 varies the pitch of the tines 78 on the bat tube or second shaft 74.

The flange portions 116 and 120 on the cam follower 112 substantially eliminate the possibility of the cam follower 112 falling out of the cam 94 as can happen with a follower in a C-shaped channel without a retainer arrangement (such as a retainer plate at the outer end of the C-shaped channel). Construction of the cam 94 as inner and outer cam rings 98 and 102 in combination with the flange cam follower 112 prevents the cam follower 112 from falling out of the cam 94.

The illustrated cam path arrangement 90 provides for infinitely variable cam paths 96 (one shown) with little or no tooling or replacement parts required. The cam path arrangement 90 provides cam actuated pitch control for the pickup reel 14. The pitch control of the tines 78 is done via the eccentric and, possibly, non-circular cam 94 connected to the bat tube or second shaft 74 through the cam follower 112 connected to the crank arm 76 on each second shaft 74. The cam 94 is preferably stationary and includes the inner and outer cam rings 98 and 102 to establish and define the cam path 96.

Also, construction of the cam 94 as inner and outer cam rings 98 and 102 and as cam segments 164, 166, 168 and 170 results in easier assembly of the cam 94 and easier installation of the cam followers 112. In addition, construction of the cam 94 as inner and outer cam rings 98 and 102 requires no special tooling to make an infinite variety of cams 94 (one shown) defining an infinite variety of cam paths 96 (one shown). The components of the cam 94 can be manufactured by any method such as laser cutting, water jet cutting, etc.

It should be understood that, in other constructions (not shown), the retainer may have a different construction to retain the cam follower in engagement with the cam during movement of the cam follower along the cam path. For example, in another construction, the cam may be formed as a generally C-shaped channel, such as that illustrated in U.S. Pat. No. 6,170,244. In such a construction, the C-shaped channel is open on the axially-inward side of the cam. To retain the cam follower in such a C-shaped channel, a retainer plate may be connected to the open side of the C-shaped cam channel to provide a reduced, more narrow opening through which, the cam follower cannot fit. Such a retainer plate would prevent the cam follower from “falling out” of or disengaging from the C-shaped channel during movement of the cam follower along such a cam path.

Various features of the invention are set forth in the claims.

I claim:

1. A pickup reel for a harvesting machine, the harvesting machine including a frame having a front edge and a cutterbar extending along the front edge, said reel comprising:
a reel support supported by the frame;
a first shaft rotatably supported by the reel support and extending along an axis transverse to the frame;
an arm extending radially from and being rotatable with the shaft;
a second shaft supported by the arm and radially spaced from the first shaft, the second shaft being rotatable relative to and rotatable with the arm;
a plurality of tines supported by the second shaft for rotation with the second shaft, each of the plurality of tines having a tip, the tips being movable along a tip path during rotation of the first shaft;
a cam supported by the reel support and defining a generally endless cam path extending about the first shaft;
a cam follower engageable with the cam and movable along the cam path;
a crank arm connected between the cam follower and the second shaft, wherein rotation of the first shaft and movement of the cam follower along the cam path cooperate to cause the tips to move along the tip path; and
a retainer including
on one of the cam and the cam follower, a first surface and a second surface axially spaced from the first surface, and
a portion of the other of the cam and the cam follower positioned between the first surface and the second surface to retain the cam follower in engagement with the cam during movement of the cam follower along the cam path.

2. The pickup reel as set forth in claim 1 wherein the cam includes an inner cam ring and an outer cam ring spaced radially outwardly of the inner cam ring, the inner cam ring and the outer cam ring defining a cam channel therebetween, the cam follower being movable in the cam channel and along the cam path, the cam follower providing the first surface and the second surface, a portion of at least one of the inner cam ring and the outer cam ring being positioned between the first surface and the second surface to retain the cam follower in engagement with the cam during movement of the cam follower in the cam channel.

3. The pickup reel as set forth in claim 2 wherein the cam follower has a first flange portion, a second flange portion spaced axially from the first flange portion, and an intermediate portion positioned between and having a reduced diameter relative to the first flange portion and the second flange portion, at least one of the inner cam ring and the outer cam ring having a cam surface engageable with the intermediate portion axially between the first flange portion and the second flange portion to retain the cam follower in engagement with the cam during movement of the cam follower along the cam path.

4. The pickup reel as set forth in claim 3 wherein the inner cam ring and the outer cam ring are captured between the first flange portion and the second flange portion to retain the cam follower in engagement with the cam during movement of the cam follower along the cam path.

5. The pickup reel as set forth in claim 3 wherein the cam follower is captured between the inner cam ring and the outer cam ring.

6. The pickup reel as set forth in claim 1 wherein the plurality of tines has a pitch, wherein the cam has a first portion and a second portion, movement of the cam follower along the first portion of the cam resulting in a first pitch of the plurality of tines, movement of the cam follower along the second portion of the cam resulting in a second pitch of the plurality of tines.

7. The pickup reel as set forth in claim 1 wherein the cam path is configured to provide a tip path having an approach zone in which the plurality of tines extend outward from said reel and the tips move in a generally horizontal path to sweep the ground forward of the cutter bar and a lift zone in which the one of the plurality of second shafts rotates in a direction relative to the ground to lift the tips over the cutterbar and above the frame.

8. The pickup reel as set forth in claim 7 wherein the harvesting machine further includes a crop dam rearward of the cutterbar, and wherein, in the lift zone, the plurality of tines lift crop over the crop dam.

9. The pickup reel as set forth in claim 7 wherein, in the lift zone, the tips move upward and rearward relative to the cutterbar.

10. The pickup reel as set forth in claim 1 wherein the cam includes a first cam segment and a second cam segment, the first cam segment and the second cam segment being connectable to define the cam path.

11. The pickup reel as set forth in claim 10 wherein one of the first cam segment and the second cam segment is selectively removable and replaceable with a third cam segment, the third cam segment and the other of the first cam segment and the second cam segment being connectable to define a second cam path different than the first-mentioned cam path, the cam follower being movable along the second cam path to cause the tips to move along a second tip path different than the first-mentioned tip path.

12. The pickup reel as set forth in claim 10 wherein one of the first cam segment and the second cam segment forms a crop engagement region of the cam path, the plurality of tines being engageable with crop during movement of the cam follower in the crop engagement region of the cam path.

13. A pickup reel for a harvesting machine, the harvesting machine including a frame having a front edge and a cutterbar extending along the front edge, said reel comprising:
a reel support supported by the frame;
a first shaft rotatably supported by the reel support and extending along an axis transverse to the frame;
a plurality of arms extending radially from and being rotatable with the shaft, each of the plurality of arms having an end spaced from the first shaft;
a plurality of second shafts extending generally parallel with the first shaft, each of the plurality of second shafts being supported by at least one of the plurality of arms and being rotatable relative to and rotatable with the at least one of the plurality of arms;
a plurality of tines supported by one of the plurality of second shafts for rotation with the one of the plurality of second shafts, each of the plurality of tines having a tip, the tips being movable along a tip path during rotation of the first shaft;
a cam supported by the reel support and defining a generally endless cam path extending about the first shaft;
a cam follower engageable with the cam and movable along the cam path;
a crank arm connected between the cam follower and the one of the plurality of second shafts, wherein rotation of the first shaft and movement of the cam follower along the cam path cooperate to cause the tips to move along the tip path; and
a retainer provided by at least one of the cam and the cam follower to retain the cam follower in engagement with the cam during movement of the cam follower along the cam path, the retainer including
a first surface and a second surface axially spaced from the first surface on one of the cam and the cam follower, and
a portion on the other of the cam and the cam follower positioned between the first surface and the second surface to prevent relative axial movement of the portion beyond the first surface and the second surface.

14. The pickup reel as set forth in claim 13 wherein the cam includes an inner cam ring and an outer cam ring spaced radially outwardly of the inner cam ring, the inner cam ring and the outer cam ring defining a cam channel therebetween, the cam follower being movable in the cam channel and along the cam path, the cam follower providing the first surface and the second surface, a portion of at least one of the inner cam ring and the outer cam ring being positioned between the first surface and the second surface to retain the cam follower in engagement with the cam during movement of the cam follower in the cam channel.

15. The pickup reel as set forth in claim 14 wherein the cam follower has a first flange portion, a second flange portion spaced axially from the first flange portion, and an intermediate portion between the first flange portion and the second flange portion, the intermediate portion having a reduced diameter, at least one of the inner cam ring and the outer cam ring having a cam surface engageable with the intermediate portion axially between the first flange portion and the second flange portion to retain the cam follower in engagement with the cam during movement of the cam follower along the cam path.

16. The pickup reel as set forth in claim 15 wherein the inner cam ring and the outer cam ring are captured between the first flange portion and the second flange portion to retain the cam follower in engagement with the cam during movement of the cam follower along the cam path.

17. The pickup reel as set forth in claim 15 wherein the cam follower is captured between the inner cam ring and the outer cam ring.

18. The pickup reel as set forth in claim 13 wherein the plurality of tines has a pitch, wherein the cam has a first portion and a second portion, movement of the cam follower along the first portion of the cam resulting in a first pitch of the plurality of tines, movement of the cam follower along the second portion of the cam resulting in a second pitch of the plurality of tines.

19. The pickup reel as set forth in claim 13 wherein the cam path is configured to provide a tip path having an approach zone in which the plurality of tines extend outward from said reel and the tips move in a generally horizontal path to sweep the ground forward of the cutter bar and a lift zone in which the one of the plurality of second shafts rotates in a direction relative to the ground to lift the tips over the cutterbar and above the frame.

20. The pickup reel as set forth in claim 19 wherein the harvesting machine further includes a crop dam rearward of the cutterbar, and wherein, in the lift zone, the plurality of tines lift crop over the crop dam.

21. The pickup reel as set forth in claim 19 wherein, in the lift zone, the tips move upward and rearward relative to the cutterbar.

22. The pickup reel as set forth in claim 13 wherein the cam includes a first cam segment and a second cam segment, the first cam segment and the second cam segment being connectable to define the cam path.

23. The pickup reel as set forth in claim 22 wherein one of the first cam segment and the second cam segment is selectively removable and replaceable with a third cam segment, the third cam segment and the other of the first cam segment and the second cam segment being connectable to define a second cam path different than the first-mentioned cam path, the cam follower being movable along the second cam path to cause the tips to move along a second tip path different than the first-mentioned tip path.

24. The pickup reel as set forth in claim 22 wherein one of the first cam segment and the second cam segment forms a crop engagement region of the cam path, the plurality of tines being engageable with crop during movement of the cam follower in the crop engagement region of the cam path.

25. A pickup reel for a harvesting machine, the harvesting machine including a frame having a forward portion, said reel comprising:
a reel support supported by the frame;
a first shaft rotatably supported by the reel support and extending along an axis transverse to the frame;
an radially extending arm extending from and rotatable with the shaft, the arm having an end spaced from the first shaft;
a second shaft supported adjacent the end of the arm and extending generally parallel with the first shaft, the second shaft being rotatable relative to the arm and being rotatable with the arm;
a tine supported by the second shaft for rotation with the second shaft, the tine having a tip, the tip being movable along a tip path during rotation of the first shaft; and
path defining structure including
an outer path member extending about the axis,
an inner path member extending about the axis and spaced radially inwardly of the outer path member, the inner path member and the outer path member defining a space therebetween extending about the axis,
a path follower movable along the inner path member and the outer path member in the space defined therebetween along a second path about the axis, the path follower member having a first keeper surface, a second keeper surface axially spaced from the first keeper surface, and a center portion therebetween, a portion of the inner path member and a portion of the outer path member being positioned between the first keeper surface and the second keeper surface to prevent movement of the portion axially beyond the first keeper surface and the second surface, and
a crank arm connected between the path follower and the second shaft; p1 wherein rotation of the first shaft causes movement of the second shaft about the axis and movement of the path follower along the path member, wherein movement of the path follower along the path member causes movement of the second shaft relative to the arm, and wherein rotation of the first shaft and movement of the path follower along the path member cooperate to cause the tip to move along the tip path.
